(19) United States
(12) Patent Application Publication
(10) Pub. No.: US 2024/0013401 A1
(43) Pub. Date: Jan. 11, 2024

(54) IDENTIFYING AND TRACKING ABANDONED OBJECTS USING VIDEO ANALYTICS

(71) Applicant: Honeywell International Inc., Charlotte, NC (US)

(72) Inventors: Aishwarya Mahajan, Madhya Pradesh (IN); Manjuprakash Rama Rao, Bangalore (IN); Joe Manjiyil, Bangalore (IN); Abhisekh Jain, Madurai (IN); Sri Harsha Paladugula, Andhra Pradesh (IN)

(21) Appl. No.: 17/861,135

(22) Filed: Jul. 8, 2022

(51) Int. Cl. G06T 7/20; G06V 20/40; G06V 40/10; G06T 7/579; G06V 20/52; G08B 21/24

(52) U.S. Cl. CPC G06T 7/20; G06V 20/41; G06V 40/10; G06T 7/579; G06V 20/52; G08B 21/24; G06T 2207/10016; G06T 2207/30196; G06T 2207/30232

(57) ABSTRACT

A method for detecting an abandoned object in a video stream captured by a video camera includes receiving a plurality of video frames of the video stream. Video analytics are performed on one or more of the plurality of video frames to detect one or more objects and one or more persons in the video stream. An object-person association between one of the detected objects and one of the detected persons is identified, resulting in an object/person pair. With the object-person pair identified, the object of the object/person pair and the person of the object/person pair are each tracked through subsequent video frames. Based on the tracking of the object of the object/person pair and the tracking of the person of the object/person pair, a determination is made as to when the object of the object/person pair becomes abandoned by the person of the object/person pair.

### TECHNICAL FIELD

The present disclosure relates to security systems, and more particularly, to security systems that are configured to identify and track abandoned objects.

### BACKGROUND

Security systems often employ a number of different security system components that are useful in monitoring and/or controlling access to an area that is covered by the security system. In some cases, the security system components including video cameras. Detecting abandoned objects can be a priority in the surveillance of threats at public and private crowded places such as airport, stadium, station, and buildings. Some abandoned objects are simply left behind by a person through simple error or forgetfulness. However, some abandoned objects can present a threat to those in the surveilled area. For example, a backpack or duffel bag left in a crowded lobby or area could contain a bomb. What would be desirable would be a security system that is able to identify and track abandoned objects using video analytics, including determining who abandoned the abandoned object(s).

### SUMMARY

This disclosure relates to security systems, and more particularly, to security systems that are configured to detect and track abandoned objects using video analytics. An example may be found in a method for identifying an abandoned object in a video stream captured by a video camera. The illustrative method includes receiving a plurality of video frames of the video stream. Video analytics are performed on one or more of the plurality of video frames to detect one or more objects in the video stream. Video analytics are also performed on one or more of the plurality of video frames to detect one or more persons in the video stream. An object-person association between one of the objects detected in the video stream and one of the persons detected in the video stream is identified, resulting in an object/person pair. With the object-person pair identified, the object of the object/person pair and the person of the object/person pair are each tracked through subsequent video frames. Based on the tracking of the object of the object/person pair and the tracking of the person of the object/person pair, a determination is made as to when the object of the object/person pair becomes abandoned by the person of the object/person pair.

Another example may be found in a method for detecting an abandoned object within a video stream. The illustrative method includes receiving a plurality of video frames of the video stream. Video analytics are performed on one or more of the plurality of video frames to detect possible objects of interest. Video analytics are performed on one or more of the plurality of video frames to detect a person believed to be associated with each of the possible objects of interest. Each possible object of interest and the associated person are tracked through subsequent video frames. The illustrative method further includes detecting that one or more of the possible objects of interest have been abandoned by the person believed to be associated with that possible object of interest. The abandoned object is continued to be tracked. The person believed to be associated with the abandoned object is tracked to see if the person returns to the abandoned object. An alert is raised when the person believed to be associated with the abandoned object does not return to the abandoned object within a threshold period of time.

Another example may be found in a security system. The illustrative security system includes a video camera for producing a video stream and a controller that is operably coupled to the video camera. The controller is configured to receive a plurality of video frames of the video stream, perform video analytics on one or more of the plurality of video frames to detect one or more objects in the video stream, and perform video analytics on one or more of the plurality of video frames to detect one or more persons in the video stream. The controller is configured to identify an object-person association between one of the objects detected in the video stream and one of the persons detected in the video stream, resulting in an object/person pair, and to track the object of the object/person pair and the person of the object/person pair through subsequent video frames. Based on the track of the object of the object/person pair and the track of the person of the object/person pair, the controller is configured to determine when the object of the object/person pair becomes abandoned by the person of the object/person pair, and to issue an alert when the object of the object/person pair becomes abandoned by the person of the object/person pair.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram of an illustrative security system;

FIGS. 2A and 2B are flow diagrams that together show an illustrative method that may be carried out by the illustrative security system of FIG. 1;

FIGS. 3A and 3B are flow diagrams that together show an illustrative method that may be carried out by the illustrative security system of FIG. 1;

FIG. 4 is a flow diagram showing an illustrative method that may be carried out by the illustrative security system of FIG. 1;

FIG. 5 is a flow diagram showing an illustrative method that may be carried out by the illustrative security system of FIG. 1;

FIG. 6 is a flow diagram showing an illustrative method that may be carried out by the illustrative security system of FIG. 1;

FIGS. 7A and 7B are flow diagrams that together show an illustrative method that may be carried out by the illustrative security system of FIG. 1;

FIGS. 8A and 8B are flow diagrams that together show an illustrative method that may be carried out by the illustrative security system of FIG. 1;

FIGS. 9A and 9B are flow diagrams that together show an illustrative method that may be carried out by the illustrative security system of FIG. 1;

FIGS. 10A and 10B are flow diagrams that together show an illustrative method that may be carried out by the illustrative security system of FIG. 1; and

FIGS. 11A and 11B are flow diagrams that together show an illustrative method that may be carried out by the illustrative security system of FIG. 1.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

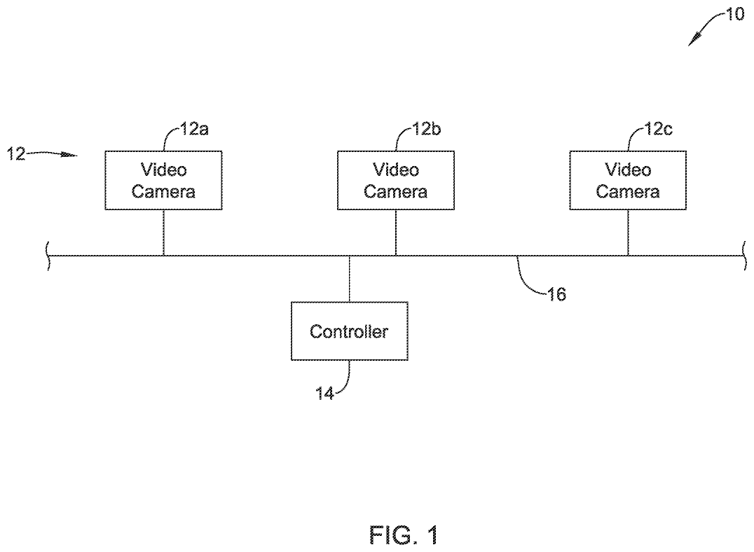

FIG. 1 is a schematic block diagram of an illustrative security system 10. The illustrative security system 10 may include a number of video cameras 12, individually labeled as 12a, 12 and 12c. While a total of three video cameras 12 are shown, this is merely illustrative. In some cases, the security system 10 may only have one video camera 12, or two video cameras 12. In some cases, the security system 10 may have a large number of video cameras 12. Each of the video cameras 12 provide a video stream including a plurality of video frames. In some cases, the security system 10 may be considered a surveillance system. In some instances, the phrase “security system” and “surveillance system” may be used interchangeably.

A controller 14 is operably coupled to the video cameras 12 via a network 16. The network 16 may be a wired network or a wireless network, for example. In some cases, the network 16 may be part of a building management system (BMS) network. In some cases, the network 16 may be a standalone network dedicated to the security system 10, while in other cases, the network 16 may be an IT network or a combination IT network and BMS network.

The controller 14 is configured to receive a plurality of video frames of the video stream from one or more of the video cameras 12 and to perform video analytics on one or more of the plurality of video frames to detect one or more objects in the video stream, as well as to detect one or more persons in the video stream. In some cases, detecting an object may include identifying one or more characteristics of the object that may be used in finding that object in subsequent frames, thereby making it easier to track the object. In some cases, detecting one or more persons may include identifying one or more characteristics of the person that may be used in finding that person in subsequent frames, thereby making it easier to track the person. In the example of FIG. 1, the controller 14 is further configured to identify an object-person association between one of the objects detected in the video stream and one of the persons detected in the video stream, resulting in an object/person pair and to track the object of the object/person pair and the person of the object/person pair through subsequent video frames of the video stream. In some cases, an image corresponding to a first occurrence of the object-person association may be archived for future processing. In some cases, for every abandoned object, one or more evidence images of the abandoned object and the associated person may be stored for later reference.

In some cases, attribute recognition may be performed in order to better track a person, who may for example be associated with a particular object such as an abandoned object, through subsequent video frames. Attribute recognition may include recognizing particular attributes pertaining to clothing that the person is wearing, the size of the person, the age of the person and the gender of the person, for example. Clothing-related attributes may include upper clothing color, lower clothing color, long sleeves, short sleeves, long pants and short pants, for example. Attribute recognition may include recognizing a person's age (adult/child) and/or gender (male/female. Any combination of these and other attributes may be used in tracking a person through multiple video frames.

In some cases, the object of the object/person pair and/or the person of the object/person pair may be tracked across the video streams of the plurality of video cameras 12a-12c. For example, the person of the object/person pair may be first detected in the video stream of a first video camera 12a, but as the person moves about the facility, the person may move out of the field of view of the first video camera 12a and into the field of view of a second video camera 12b. The controller 14 may be configured to track the person of the object/person pair across the video streams of the plurality of video cameras 12a-12c. Alternative, or in addition, the controller 14 may be configured to track the object of the object/person pair across the video streams of the plurality of video cameras 12a-12c.

Based on continuing to track of the object of the object/person pair and continuing to track the person of the object/person pair, the controller 14 is configured to determine when the object of the object/person pair becomes abandoned by the person of the object/person pair, and to issue an alert when the object of the object/person pair becomes abandoned by the person of the object/person pair. As an example, the alert may identify the abandoned object of the object/person pair, and the person that abandoned the object of the object/person pair. In some cases, the controller 14 may be further configured to archive an image of the abandoned object of the object/person pair and an image of the person that abandoned the object of the object/person pair when the object of the object/person pair becomes abandoned by the person of the object/person pair. In some cases, the alert may include a current location of the object of the object/person pair and/or a current location of the person of the object/person pair. In some cases, the alert may include an additional archived image of the first object-person association.

In some cases, and after the object of the object/person pair becomes abandoned by the person of the object/person pair, the controller 14 is configured to continue to track the abandoned object of the object/person pair and to continue to track the person that abandoned the object of the object/person pair. Based on the continued tracking of the abandoned object of the object/person pair and the person that abandoned the object of the object/person pair, the controller 14 may be configured to determine whether the person that abandoned the object of the object/person pair returns to the abandoned object of the object/person pair, and if so, determines that the abandoned object of the object/person pair is no longer abandoned by the person of the object/person pair. This is just an example.

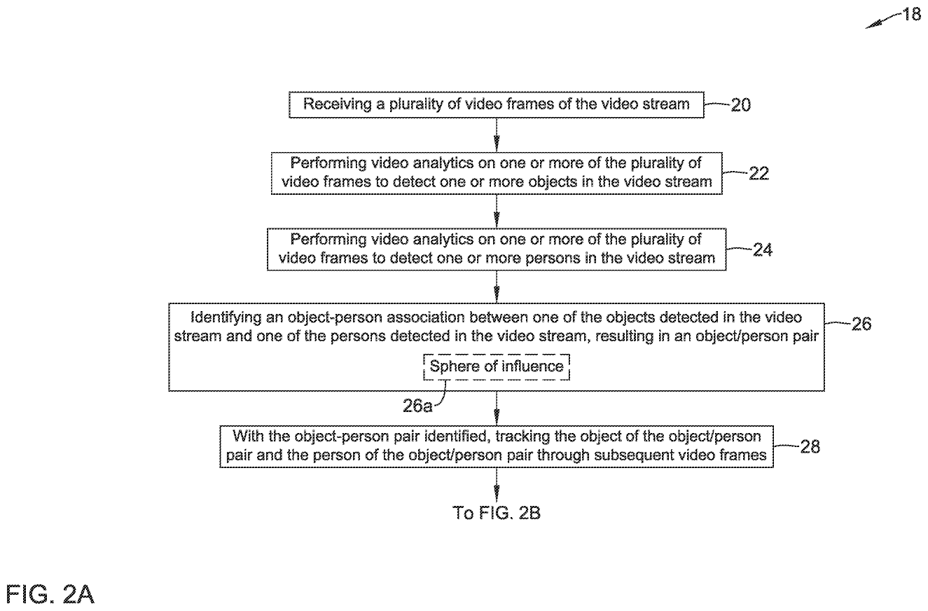

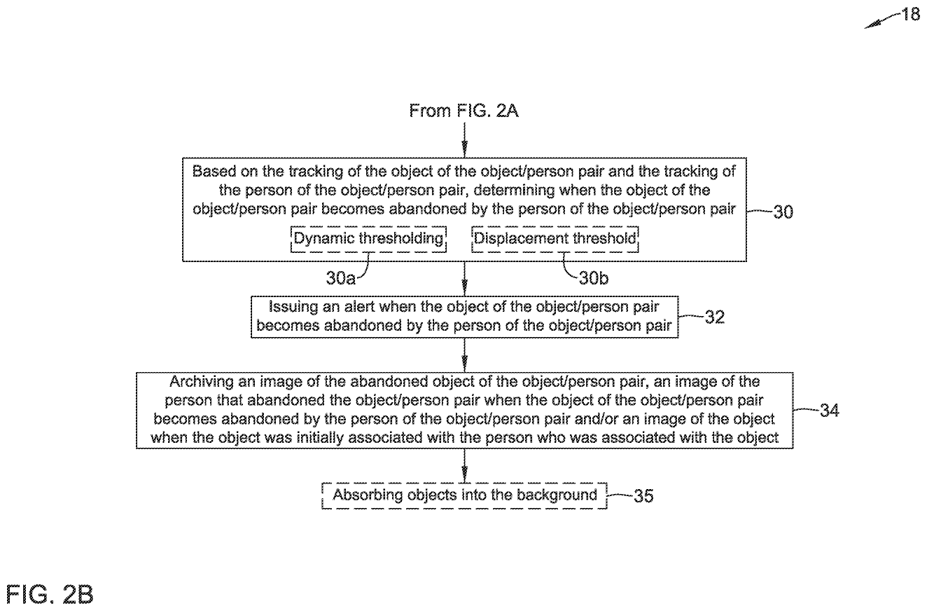

FIGS. 2A and 2B are flow diagrams that together show an illustrative method 18 for identifying an abandoned object in a video stream captured by a video camera (such as video camera 12a). The illustrative method 18 includes receiving a plurality of video frames of the video stream, as indicated at block 20. Video analytics are performed on one or more of the plurality of video frames to detect one or more objects in the video stream, as indicated at block 22. Video analytics are performed on one or more of the plurality of video frames to detect one or more persons in the video stream, as indicated at block 24. Video analytics to detect objects in a video stream and video analytics to detect persons in a video stream are known in the art. An object-person association between one of the objects detected in the video stream and one of the persons detected in the video stream is identified, resulting in an object/person pair, as indicated at block 26. With the object-person pair identified, the object of the object/person pair and the person of the object/person pair are both tracked through subsequent video frames, as indicated at block 28.

Continuing on FIG. 2B, and based on the tracking of the object of the object/person pair and the tracking of the person of the object/person pair, a determination is made as to when the object of the object/person pair becomes abandoned by the person of the object/person pair, as indicated at block 30. For example, if the person of the object/person pair becomes separated from the object of the object/person pair by more than a threshold distance and for more than a threshold time, it may be determined that the object of the object/person pair becomes abandoned by the person of the object/person pair. In some cases, the threshold distance may be based on the size of the object (e.g. number of pixels) so to as to scale the separation distance to take into account the distance that the object and/or person of the object/person pair are from the video camera.

In some cases, and as indicated at block 30a, dynamic thresholding may be used in determining what the threshold distance is, for example. If an object is in the foreground of a video frame, that object will appear relatively larger and will consume a relatively larger number of pixels. A similarly sized object in the background of a video frame will appear relatively smaller, and will consume a relatively smaller number of pixels. A movement of three (as an example) pixels for the object (or bounding box around the object) in the foreground may barely count as movement, while the same movement of three pixels for the object (or bounding box around the object) in the background may count as a significant movement.

For an object to be abandoned, it is required to be stationary for a least a period of time. To determine whether the object has moved or is stationary, a continual check is performed as to whether the object is displaced or not from a prior frame, as indicated at block 30b. For each object, a relative displacement for a current and a previous frame is computed. Those objects that have a relative displacement that is less than a displacement threshold are considered for favorable candidate stationary objects.

While addressing the candidate stationary object, having a fix displacement threshold may be simple, but may limit the scalability of identifying movement in the video stream. For example, when the person is in the far field of view, a small pixel distance will translate to a large physical displacement distance and vice versa when the person/object is in the near field of view. Accordingly, the relative size of the object or person, or bounding box around either the object or the person, may be used in determining the displacement threshold used for determining whether an object is stationary or not. As an example, and in some cases, the minimum length of the sides of the bounding box of an object may be determined, and a particular percentage of that minimum length may be selected as the displacement threshold. For example, the displacement (or distance) threshold may be set equal to 8% of the minimum length, although other percentages are contemplated.

Likewise, and in some cases, dynamic thresholding may be used to determine a virtual region of interest or sphere of influence, as indicated at block 2a, inside of which an object and a person are considered to be associated by virtue of the distance there between. In some cases, this may be addressed by dividing the field of view into three (or more) zones. In one example, a far field of view may defined as the top 8% of the height of the image, the near field of view may correspond to the bottom 10% of the height of the image, and the intervening zone, between the far field of view and the near field of view, may be considered the active field of view. In some cases, the virtual region of interest may then be dynamically ascertained based on the object height as follows:

For objects in the far field of view zone, the following equation may be used:

```
    virtual_roi_distance_thresh = 50 * (image_height/1080).
For objects in the near field of view zone, the following equation may be used:
        virtual_roi_distance_thresh = 120 * (image_height/1080).
For objects in the active field of view zone, the following equations may be used:
  image_height_remaining = image_height − (image_height * 0.08) − (image_height * 0.10);
    virtual_roi_distance_thresh = 50 + (obj_centroid_height − (image_height * 0.08))*
          image_height_remaining,
where:
    virtual_roi_distance_thresh is the radius of the virtual region of interest of which an
      object and a person are considered to be associated by virtue of the distance
      therebetween;
    image_height is the pixelwise image/frame height of the frame received as the video
      sequences;
    object_centroid_height is the pixelwise distance of the object center from the top of the
      object; and
    image_height_remaining is the pixelwise remaining length excluding the near and far
      field of view zones.
```

In some cases, a sensitivity parameter may be used to dynamically scale the virtual region of interest. The sensitivity parameter may scale how far the person can move from an object without the object being considered abandoned. For example, it may be desirable for some areas of a facility to have a higher sensitivity than other areas of a facility. In some cases, the sensitivity parameter can be set to high sensitivity, medium sensitivity or low sensitivity. As an example:

High Sensitivity means radius_virtual_roi=2⁰*virtual_roi_distance_thresh;

Medium Sensitivity means radius_virtual_roi=2¹*virtual_roi_distance_thresh, and

Low Sensitivity means radius_virtual_roi=2²*virtual_roi_distance_thresh.

In some cases, and as indicated at block 35, stationary objects that were never associated with a person and never determined to be abandoned may be identified in a particular scene. Over time, it may be appropriate to absorb these objects into the background in order to reduce false positives. The number of abandoned events associated with detected objects that are not associated with a person, and were never associated with a person, is evaluated relative to a threshold number of observed events. Once the number of abandoned events exceed the threshold for a particular object, the subsequent abandoned object alarm events associated with that object is suppressed and may be considered as absorbing/merging the object into background. To merge/absorb the object, the features and color attributes of the object are compared with respect to the same position as an abandoned object is assumed to be stationary for the n-2^{th}, n-1^{th} and n^{th} event before it crossed the threshold count “n” for the event. If either of the comparison in between is matched, the object is marked for Absorption with the Background.

In some cases, the method 18 may include issuing an alert when the object of the object/person pair becomes abandoned by the person of the object/person pair, as indicated at block 32. As an example, the alert may identify the abandoned object of the object/person pair and/or the person that abandoned the object of the object/person pair. The method 18 may further include archiving an image of the abandoned object of the object/person pair, an image of the person that abandoned the object of the object/person pair when the object of the object/person pair becomes abandoned by the person of the object/person pair, and/or an image of the object when the object was initially associated with the person who was associated with the object, as indicated at block 34. In some cases, the alert may include a current location of the object of the object/person pair and/or a current location of the person of the object/person pair.

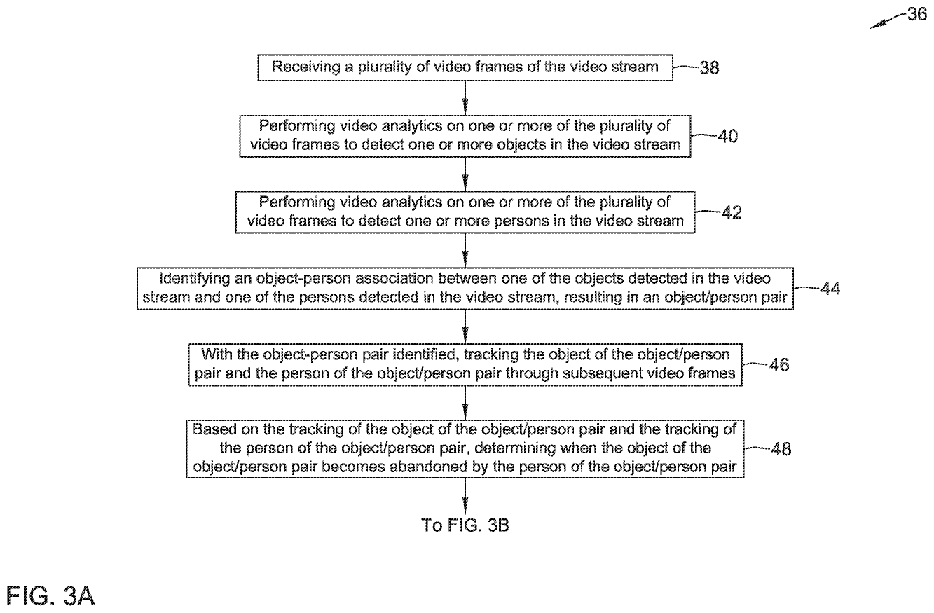

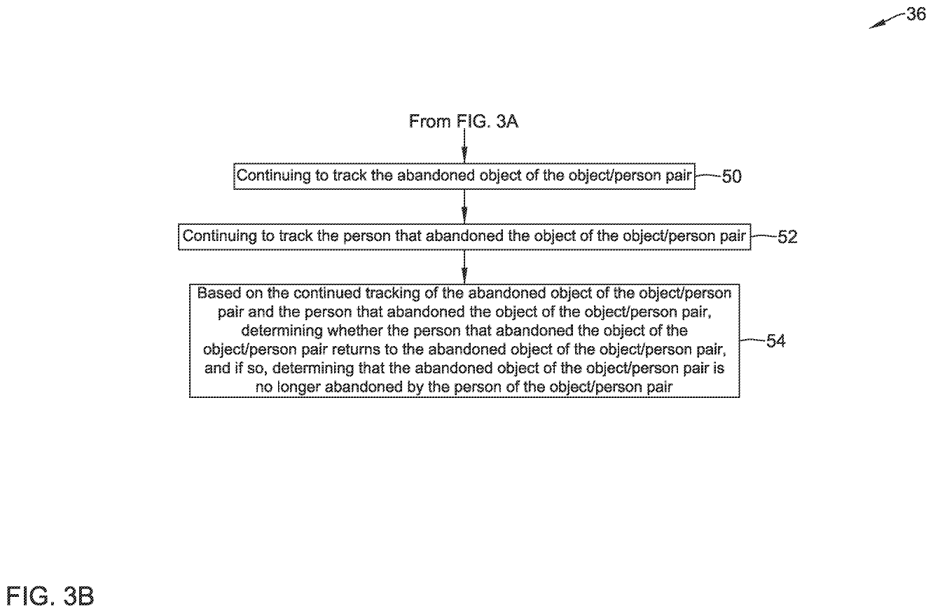

FIGS. 3A and 3B are flow diagrams that together show an illustrative method 36 for identifying an abandoned object in a video stream captured by a video camera (such as the video camera 12). The method 36 includes receiving a plurality of video frames of the video stream, as indicated at block 38. Video analytics are performed on one or more of the plurality of video frames to detect one or more objects in the video stream, as indicated at block 40. Video analytics are performed on one or more of the plurality of video frames to detect one or more persons in the video stream, as indicated at block 42.

An object-person association between one of the objects detected in the video stream and a person detected in the video stream is identified, resulting in an object/person pair, as indicated at block 44. With the object-person pair identified, the object of the object/person pair and the person of the object/person pair are both tracked through subsequent video frames, as indicated at block 46. Based on the tracking of the object of the object/person pair and the tracking of the person of the object/person pair, a determination is made as to when the object of the object/person pair becomes abandoned by the person of the object/person pair, as indicated at block 50.

The illustrative method 36 continues in FIG. 3B, which outlines steps taken after the object of the object/person pair becomes abandoned by the person of the object/person pair. The method 36 includes continuing to track the abandoned object of the object/person pair, as indicated at block 50, and continuing to track the person that abandoned the object of the object/person pair, as indicated at block 52. Based on the continued tracking of the abandoned object of the object/person pair and the continued tracking of the person that abandoned the object of the object/person pair, a determination is made as to whether the person that abandoned the object of the object/person pair returns to the abandoned object of the object/person pair, and if so, a determination is made that the abandoned object of the object/person pair is no longer abandoned by the person of the object/person pair, as indicated at block 54.

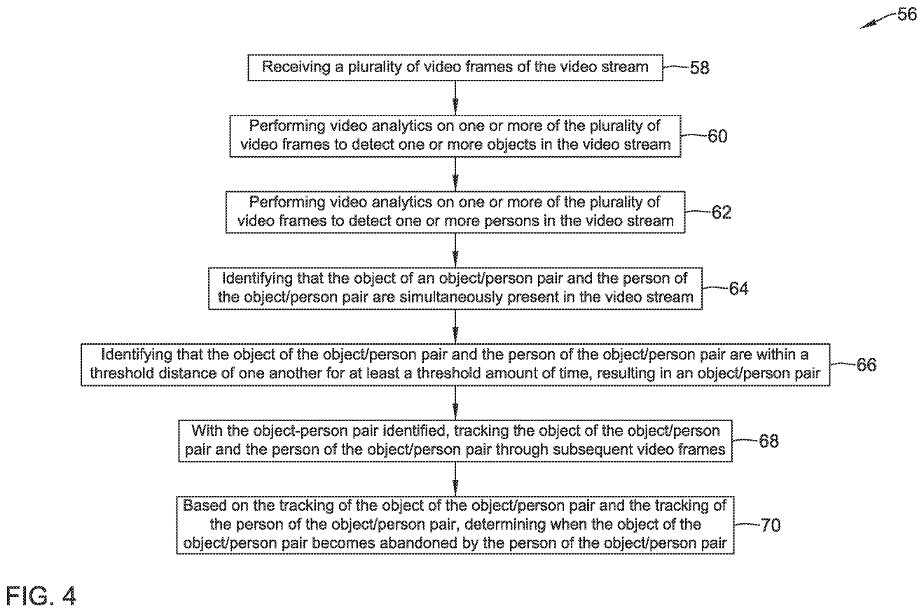

FIG. 4 is a flow diagram showing an illustrative method 56 for detecting an abandoned object in a video stream captured by a video camera (such as the video camera 12). The illustrative method 56 includes receiving a plurality of video frames of the video stream, as indicated at block 58. Video analytics are performed on one or more of the plurality of video frames to detect one or more objects in the video stream, as indicated at block 60. Video analytics are performed on one or more of the plurality of video frames to detect one or more persons in the video stream, as indicated at block 62.

The method 56 includes identifying a candidate object of a candidate object/person pair and a candidate person of the candidate object/person pair are simultaneously present in the video stream, as indicated at block 64. The method 56 further includes identifying that the candidate object of the candidate object/person pair and the candidate person of the candidate object/person pair are within a threshold distance of one another for at least a threshold amount of time. When these conditions are satisfied, sometimes in combination with other satisfied conditions, the method may identify that the candidate object and the candidate person are associated as object/person pair, as indicated at block 66.

With the object-person pair identified, the object of the object/person pair and the person of the object/person pair are both tracked through subsequent video frames, as indicated at block 68. Based on the tracking of the object of the object/person pair and the tracking of the person of the object/person pair, a determination is made as to when the object of the object/person pair becomes abandoned by the person of the object/person pair, as indicated at block 70.

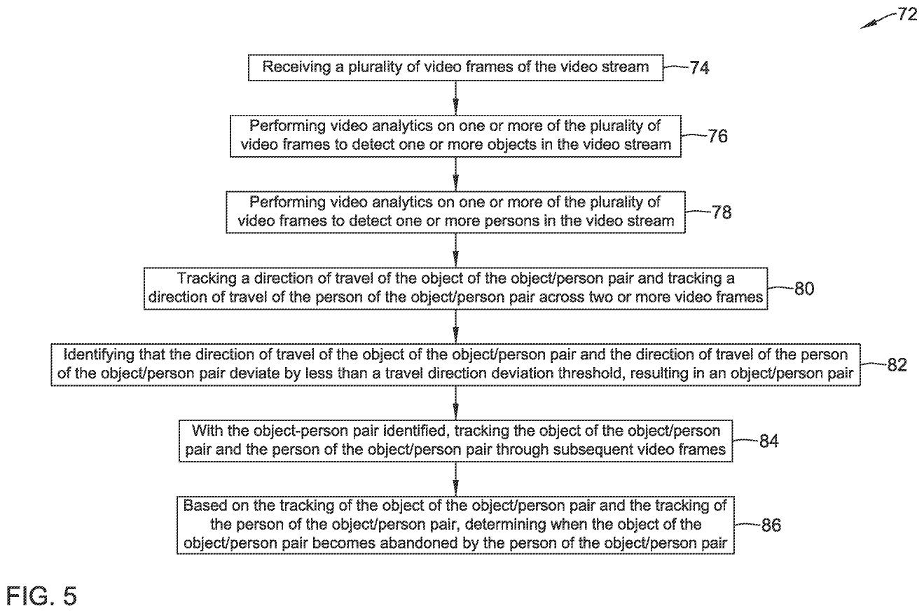

FIG. 5 is a flow diagram showing an illustrative method 72 for identifying an abandoned object in a video stream captured by a video camera (such as a video camera 12a). The illustrative method 72 includes receiving a plurality of video frames of the video stream, as indicated at block 74. Video analytics are performed on one or more of the plurality of video frames to detect one or more objects in the video stream, as indicated at block 76. Video analytics are performed on one or more of the plurality of video frames to detect one or more persons in the video stream, as indicated at block 78.

The method 72 further includes tracking a direction of travel of a candidate object of a candidate object/person pair and tracking a direction of travel of a candidate person of the candidate object/person pair across two or more video frames, as indicated at block 80. The method 72 includes identifying that the direction of travel of the candidate object of the object/person pair and the direction of travel of the candidate person of the object/person pair deviate by less than a travel direction deviation threshold. When this condition is satisfied, sometimes with other conditions, the method may determine that the candidate object and the candidate person are associated as object/person pair, as indicated at block 82.

With the object-person pair identified, the object of the object/person pair and the person of the object/person pair are both tracked through subsequent video frames, as indicated at block 84. Based on the tracking of the object of the object/person pair and the tracking of the person of the object/person pair, a determination is made as to when the object of the object/person pair becomes abandoned by the person of the object/person pair, as indicated at block 86.

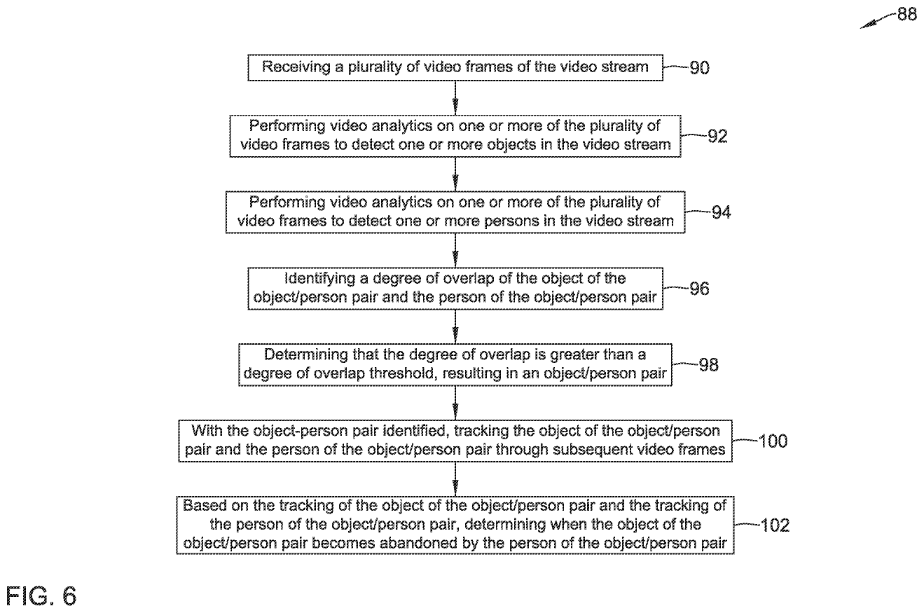

FIG. 6 is a flow diagram showing an illustrative method 88 for identifying an abandoned object in a video stream captured by a video camera (such as a video camera 12a). The illustrative method 88 includes receiving a plurality of video frames of the video stream, as indicated at block 90. Video analytics are performed on one or more of the plurality of video frames to detect one or more objects in the video stream, as indicated at block 92. Video analytics are performed on one or more of the plurality of video frames to detect one or more persons in the video stream, as indicated at block 94.

The method 88 further includes identifying a degree of overlap of a candidate object of a candidate object/person pair and a candidate person of the candidate object/person pair, as indicated at block 96. For example, an object bounding box may be established about the candidate object and a person bound box may be established about the candidate person of the candidate object/person pair. The degree of overlap may be determined as the area of intersection of the object bounding box and the person bounding box, divided by the union of the object bounding box and the person bounding box. The method 88 includes determining that the degree of overlap is greater than a degree of overlap threshold. When this condition is satisfied, sometimes in combination with other satisfied conditions, the method may determine that the candidate object and the candidate person are associated as object/person pair, as indicated at block 98.

With the object-person pair identified, the object of the object/person pair and the person of the object/person pair are both tracked through subsequent video frames, as indicated at block 100. Based on the tracking of the object of the object/person pair and the tracking of the person of the object/person pair, a determination is made as to when the object of the object/person pair becomes abandoned by the person of the object/person pair, as indicated at block 102.

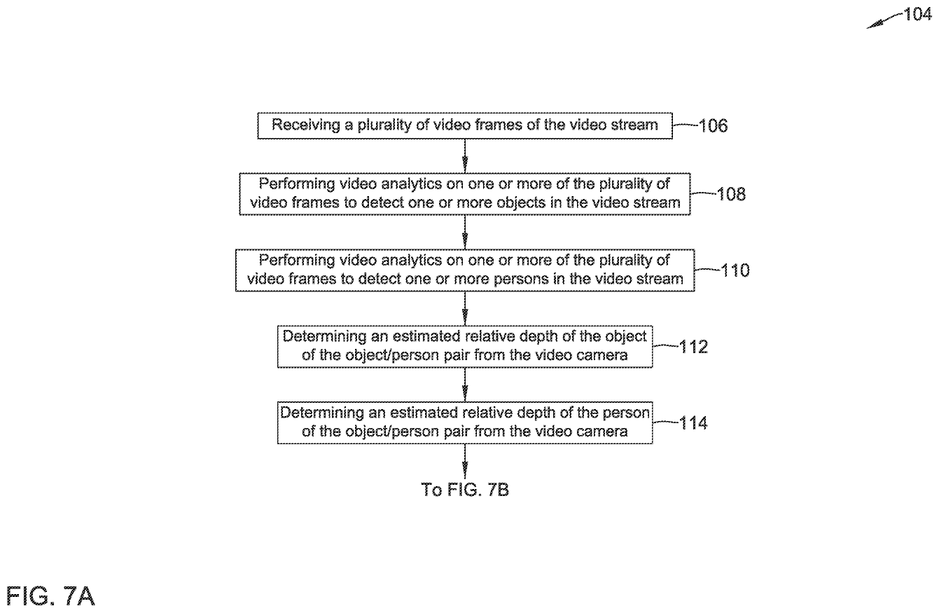

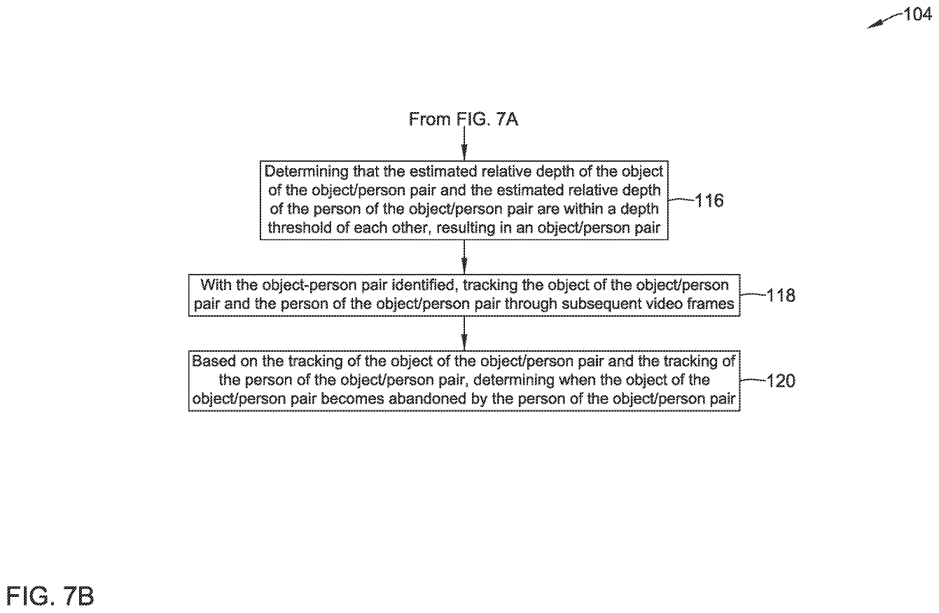

FIGS. 7A and 7B are flow diagrams that together show an illustrative method 104 for identifying an abandoned object in a video stream captured by a video camera (such as a video camera 12a). The illustrative method 104 includes receiving a plurality of video frames of the video stream, as indicated at block 106. Video analytics are performed on one or more of the plurality of video frames to detect one or more objects in the video stream, as indicated at block 108. Video analytics are performed on one or more of the plurality of video frames to detect one or more persons in the video stream, as indicated at block 110.

The method 104 further includes determining an estimated relative depth of a candidate object of a candidate object/person pair from the video camera, as indicated at block 112, and determining an estimated relative depth of a candidate person of the candidate object/person pair from the video camera, as indicated at block 114. In one example, a depth map is initially determined for the frame using a depth estimator, which computes a depth from the camera for every pixel of the input frame and outputs relative distance values as a 2-dimensional map. A bounding box of the candidate object is then overlaid on the 2-dimensional distance map, and the estimated relative depth of the candidate object is computed using the corresponding values in the 2-dimensional distance map. Likewise, a bounding box of the candidate person is overlaid on the 2-dimensional distance map, and the estimated relative depth of the candidate person is computed using the corresponding values in the 2-dimensional distance map. The method 104 continues on FIG. 7B, where the method 104 determines whether the estimated relative depth of the object of the object/person pair and the estimated relative depth of the person of the object/person pair are within a depth threshold of each other. When this condition is satisfied, sometimes in combination with other satisfied conditions, the method may determine that the candidate object and the candidate person are associated as object/person pair, as indicated at block 116.

With the object-person pair identified, the object of the object/person pair and the person of the object/person pair are both tracked through subsequent video frames, as indicated at block 118. Based on the tracking of the object of the object/person pair and the tracking of the person of the object/person pair, a determination is made as to when the object of the object/person pair becomes abandoned by the person of the object/person pair, as indicated at block 120.

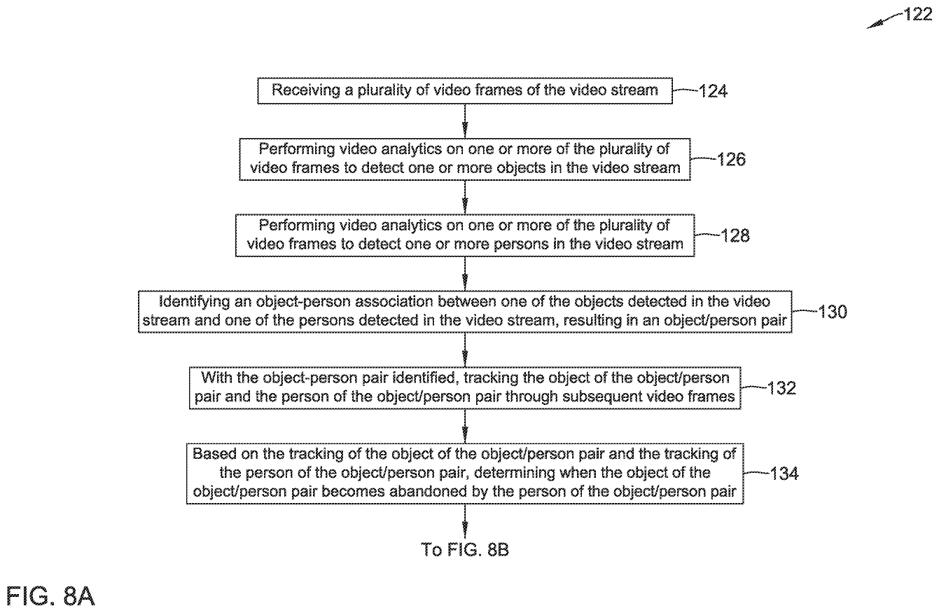

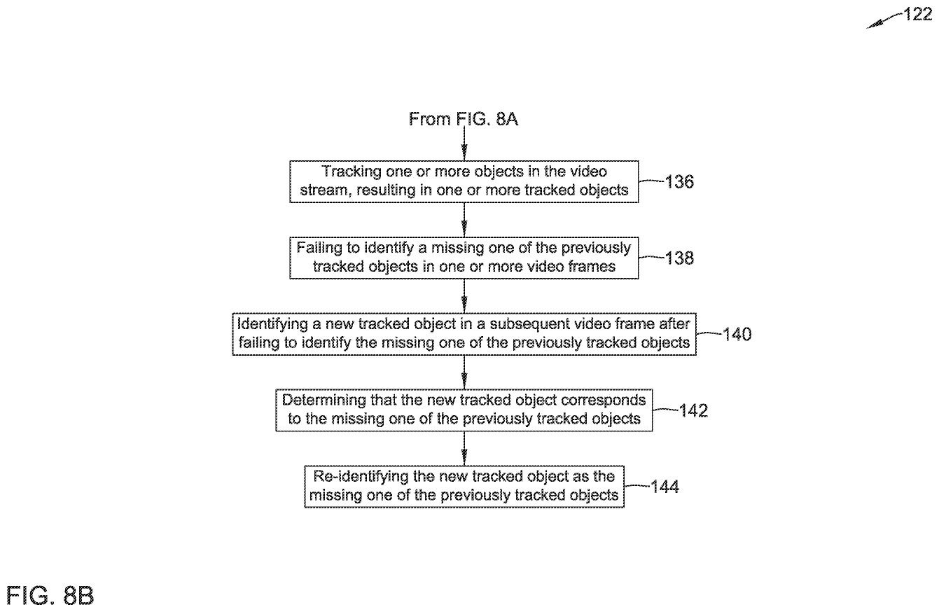

FIGS. 8A and 8B are flow diagrams that together show an illustrative method 122 for identifying an abandoned object in a video stream captured by a video camera (such as a video camera 12a). The method 122 includes receiving a plurality of video frames of the video stream, as indicated at block 124. Video analytics are performed on one or more of the plurality of video frames to detect one or more objects in the video stream, as indicated at block 126. Video analytics are performed on one or more of the plurality of video frames to detect one or more persons in the video stream, as indicated at block 128. An object-person association between one of the objects detected in the video stream and one of the persons detected in the video stream is identified, resulting in an object/person pair, as indicated at block 130.

With the object-person pair identified, the object of the object/person pair and the person of the object/person pair are both tracked through subsequent video frames, as indicated at block 132. Based on the tracking of the object of the object/person pair and the tracking of the person of the object/person pair, a determination is made as to when the object of the object/person pair becomes abandoned by the person of the object/person pair, as indicated at block 134.

The method 122 continues on FIG. 8B. As indicated above, one or more objects in the video stream are tracked, which results in one or more tracked objects as indicated at block 136. The method 122 includes failing to identify a missing one of the previously tracked objects in one or more video frames, as indicated at block 138. The previously tracked object may, for example, become temporarily obstructed from view. Later, a new tracked object is identified in a subsequent video frame after failing to identify the missing one of the previously tracked objects, as indicated at block 140. A determination is made as to whether the new tracked object corresponds to the missing one of the previously tracked objects, as indicated at block 142. As an example, this may be accomplished by feature matching between the missing one of the previously tracked objects and the new tracked object, RGB matching (mean RBG values) between the missing one of the previously tracked objects and the new tracked object, and/or angle of inclination matching between an angle of inclination of the missing one of the previously tracked objects in the frame and the angle of inclination of the new tracked object. If it is determined that the new tracked object corresponds to the missing one of the previously tracked objects, the new tracked object is re-identified as the missing one of the previously tracked objects, as indicated at block 144, and the object/person pair is updated.

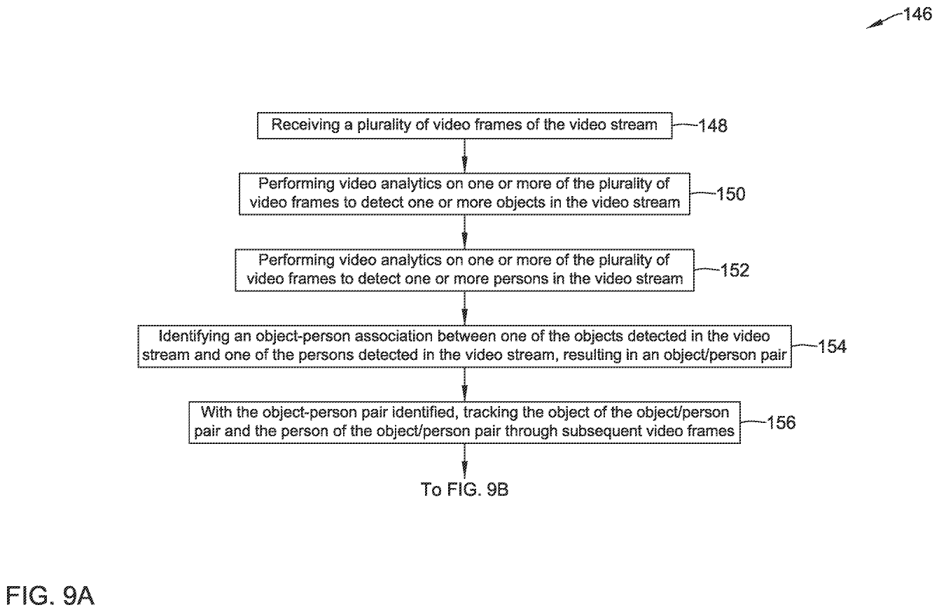

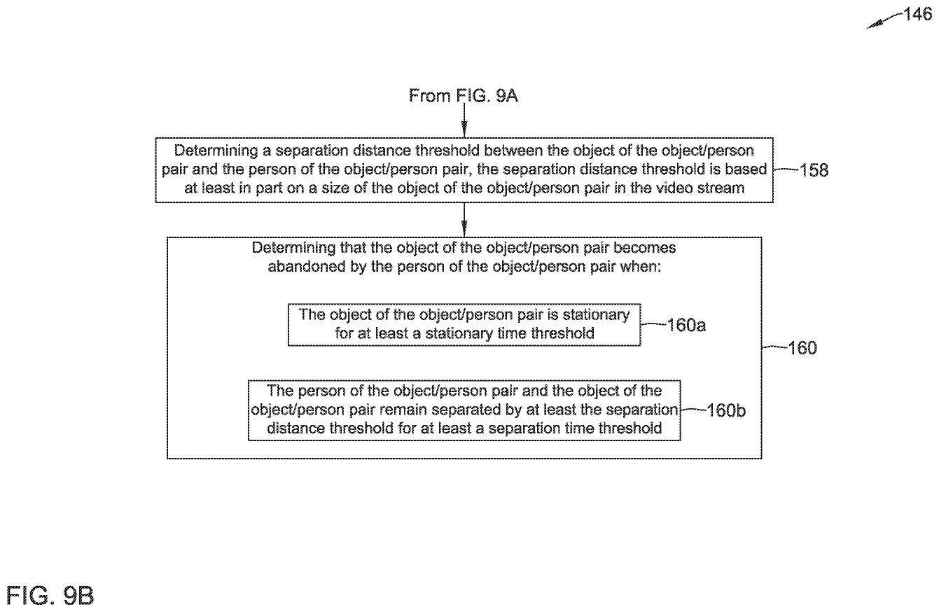

FIGS. 9A and 9B are flow diagrams that together show an illustrative method 146 of identifying an abandoned object in a video stream captured by a video camera (such as the video camera 12). The method 146 includes receiving a plurality of video frames of the video stream, as indicated at block 148. Video analytics are performed on one or more of the plurality of video frames to detect one or more objects in the video stream, as indicated at block 150. Video analytics are performed on one or more of the plurality of video frames to detect one or more persons in the video stream, as indicated at block 152. An object-person association between one of the objects detected in the video stream and one of the persons detected in the video stream is identified, resulting in an object/person pair, as indicated at block 154. With the object-person pair identified, the object of the object/person pair and the person of the object/person pair are both tracked through subsequent video frames, as indicated at block 156.

The method 146 continues on FIG. 9B, in which a determination has been made that the object of the object/person pair has become abandoned by the person of the object/person pair. The method 146 includes determining a separation distance threshold between the object of the object/person pair and the person of the object/person pair. The separation distance threshold is based at least in part on a size of the object of the object/person pair in the video stream, as indicated at block 158. For example, in some cases, a bounding box may be defined around the object of the object/person pair, and the separation distance threshold may be set as the area of a circle with a radius that is equal to the length of the longest diagonal distance of the bunding box. By having the separation distance threshold based on the size of the object (e.g. number of pixels), the separation distance threshold may be automatically scaled to take into account the distance that the object of the object/person pair is from the video camera.

The method 146 further includes determining that the object of the object/person pair becomes abandoned by the person of the object/person pair, as indicated at block 160. This determination is made when the object of the object/person pair is stationary for at least a stationary time threshold, as indicated at block 160a, and the person of the object/person pair and the object of the object/person pair remain separated by at least the separation distance threshold for at least a separation time threshold, as indicated at block 160b.

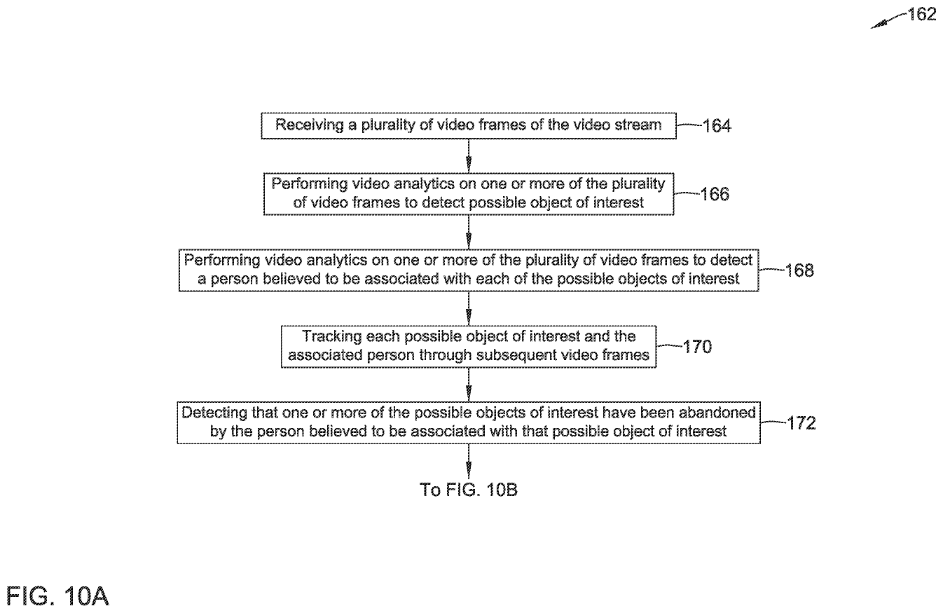

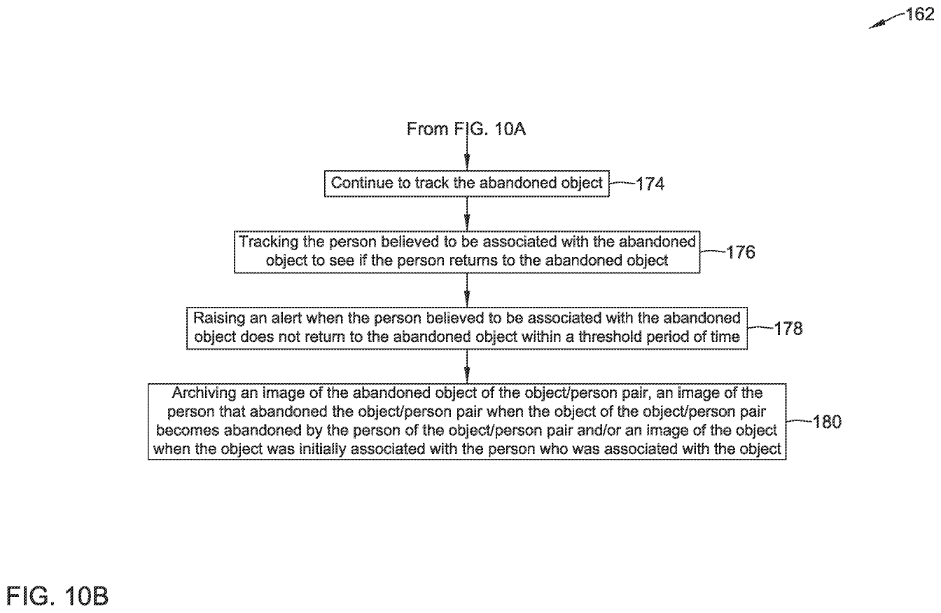

FIGS. 10A and 10b are flow diagrams that together show an illustrative method 162 for identifying an abandoned object within a video stream that includes a plurality of video frames. The method 162 includes receiving a plurality of video frames of the video stream, as indicated at block 164. Video analytics are performed on one or more of the plurality of video frames to detect possible objects of interest, as indicated at block 166. Video analytics are performed on one or more of the plurality of video frames to detect a person believed to be associated with each of the possible objects of interest, as indicated at block 168. Each possible object of interest and the associated person are tracked through subsequent video frames, as indicated at block 170. The method 162 includes detecting that one or more of the possible objects of interest have been abandoned by the person believed to be associated with that possible object of interest, as indicated at block 172.

The method 162 continues on FIG. 10B, where the abandoned object is continued to be tracked, as indicated at block 174. The person believed to be associated with the abandoned object is also tracked to see if the person returns to the abandoned object, as indicated at block 176. An alert is raised when the person believed to be associated with the abandoned object does not return to the abandoned object within a threshold period of time, as indicated at block 178.

In some cases, the alert may identify the abandoned object and the person that is believed to be associated with the abandoned object. In some cases, the alert may identify a current location of the abandoned object and/or the current location of the person that is believed to be associated with the abandoned object. In some cases, the method 162 further includes archiving an image of the abandoned object, an image of the person believed to be associated with the abandoned object and/or an image of the object when the object was initially associated with the person who was associated with the object, as indicated at block 180.

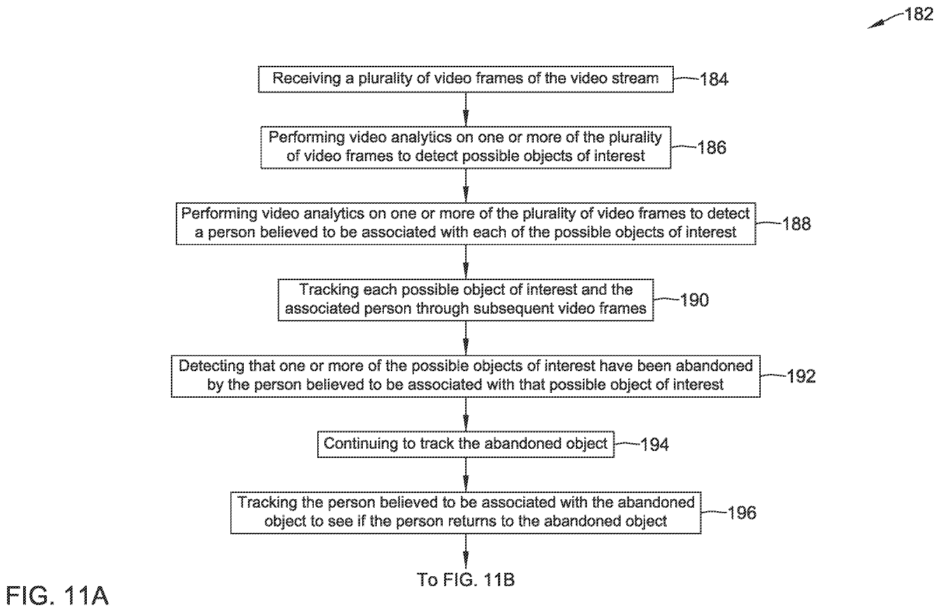

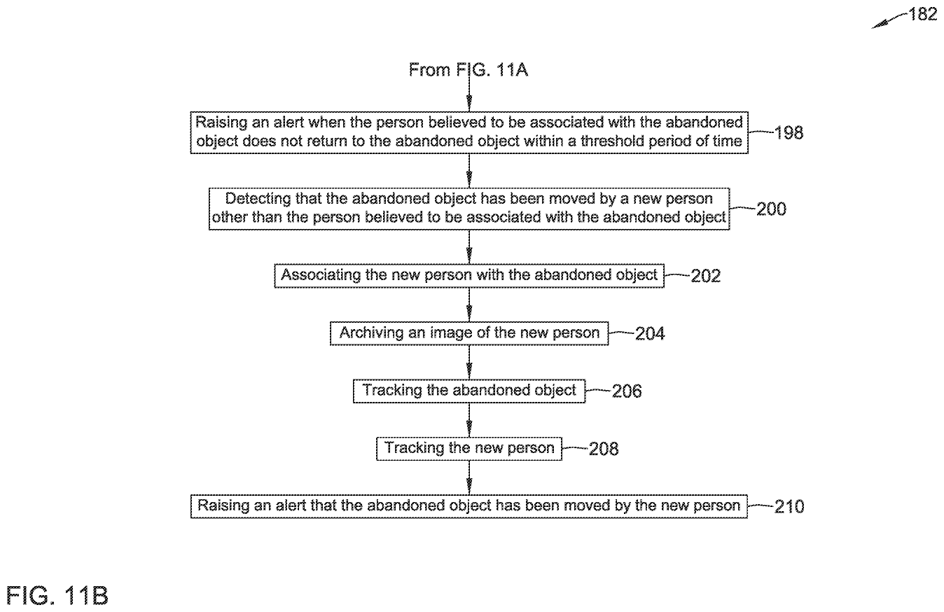

FIGS. 11A and 11B are flow diagrams that together show an illustrative method 182 for identifying an abandoned object within a video stream that includes a plurality of video frames. The method 182 includes receiving a plurality of video frames of the video stream, as indicated at block 184. Video analytics are performed on one or more of the plurality of video frames to detect possible objects of interest, as indicated at block 186. Video analytics are performed on one or more of the plurality of video frames to detect a person believed to be associated with each of the possible objects of interest, as indicated at block 188. Each possible object of interest and the associated person are tracked through subsequent video frames, as indicated at block 190. The method 182 further includes detecting that one or more of the possible objects of interest have been abandoned by the person believed to be associated with that possible object of interest, as indicated at block 192. The abandoned object is continued to be tracked, as indicated at block 194. The person believed to be associated with the abandoned object is tracked to see if the person returns to the abandoned object, as indicated at block 196.

The method 182 continues on FIG. 11B, where an alert is raised when the person believed to be associated with the abandoned object does not return to the abandoned object within a threshold period of time, as indicated at block 198. In some cases, the alert may identify one or more of the abandoned object and the person that is believed to be associated with the abandoned object. The method 182 further includes detecting that the abandon object has been moved by a new person other than the person believed to be associated with the abandoned object, as indicated at block 200. The new person is associated with the abandoned object, as indicated at block 202. An image of the new person is archived, as indicated at block 204. The abandoned object is tracked, as indicated at block 206. The new person is tracked, as indicated at block 208. An alert is raised that the abandoned object has been moved by the new person, as indicated at block 210. The alert may indicate the current location of the abandoned object and the current location of the new person.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A method for identifying an abandoned object in a video stream captured by a video camera, the method comprising:
receiving a plurality of video frames of the video stream;
performing video analytics on one or more of the plurality of video frames to detect one or more objects in the video stream;
performing video analytics on one or more of the plurality of video frames to detect one or more persons in the video stream;
identifying an object-person association between one of the objects detected in the video stream and one of the persons detected in the video stream, resulting in an object/person pair;
with the object-person pair identified, tracking the object of the object/person pair and the person of the object/person pair through subsequent video frames; and
based on the tracking of the object of the object/person pair and the tracking of the person of the object/person pair, determining when the object of the object/person pair becomes abandoned by the person of the object/person pair.

2. The method of claim 1, further comprising issuing an alert when the object of the object/person pair becomes abandoned by the person of the object/person pair.

3. The method of claim 2, wherein the alert identifies:
the abandoned object of the object/person pair; and
the person that abandoned the object of the object/person pair.

4. The method of claim 1, further comprising:
archiving an image of the abandoned object of the object/person pair and an image of the person that abandoned the object of the object/person pair when the object of the object/person pair becomes abandoned by the person of the object/person pair.

5. The method of claim 1, wherein after the object of the object/person pair becomes abandoned by the person of the object/person pair, the method comprises:
continuing to track the abandoned object of the object/person pair;
continuing to track the person that abandoned the object of the object/person pair; and
based on the continued tracking of the abandoned object of the object/person pair and the person that abandoned the object of the object/person pair, determining whether the person that abandoned the object of the object/person pair returns to the abandoned object of the object/person pair, and if so, determining that the abandoned object of the object/person pair is no longer abandoned by the person of the object/person pair.

6. The method of claim 1, wherein identifying the object-person association comprises:
determining that the object of the object/person pair and the person of the object/person pair are simultaneously present in the video stream; and
determining that the object of the object/person pair and the person of the object/person pair are within a threshold distance of one another for at least a threshold amount of time.

7. The method of claim 1, wherein identifying the object-person association comprises:
tracking a direction of travel of the object of the object/person pair and tracking a direction of travel of the person of the object/person pair across two or more video frames; and
determining that the direction of travel of the object of the object/person pair and the direction of travel of the person of the object/person pair deviate by less than a travel direction deviation threshold.

8. The method of claim 1, wherein identifying the object-person association comprises:
identifying a degree of overlap of the object of the object/person pair and the person of the object/person pair; and
determining that the degree of overlap is greater than an degree of overlap threshold.

9. The method of claim 1, wherein identifying the object-person association comprises:
determining an estimated relative depth of the object of the object/person pair from the video camera;
determining an estimated relative depth of the person of the object/person pair from the video camera; and
determining that the estimated relative depth of the object of the object/person pair and the estimated relative depth of the person of the object/person pair are within a depth threshold of each other.

10. The method of claim 1, comprising:
tracking one or more objects in the video stream, resulting in one or more tracked objects;
failing to identify a missing one of the previously tracked objects in one or more video frames;
identifying a new tracked object in a subsequent video frame after failing to identify the missing one of the previously tracked objects;
determining that the new tracked object corresponds to the missing one of the previously tracked objects; and
re-identifying the new tracked object as the missing one of the previously tracked objects.

11. The method of claim 1, wherein determining when the object of the object/person pair becomes abandoned by the person of the object/person pair comprises:
determining a separation distance threshold between the object of the object/person pair and the person of the object/person pair, the separation distance threshold is based at least in part on a size of the object of the object/person pair in the video stream;
determining that the object of the object/person pair becomes abandoned by the person of the object/person pair when:
the object of the object/person pair is stationary for at least a stationary time threshold; and
the person of the object/person pair and the object of the object/person pair remain separated by at least the separation distance threshold for at least a separation time threshold.

12. A method for identifying an abandoned object within a video stream that includes a plurality of video frames, the method comprising:
receiving a plurality of video frames of the video stream;
performing video analytics on one or more of the plurality of video frames to detect possible objects of interest;
performing video analytics on one or more of the plurality of video frames to detect a person believed to be associated with each of the possible objects of interest;
tracking each possible object of interest and the associated person through subsequent video frames;
detecting that one or more of the possible objects of interest have been abandoned by the person believed to be associated with that possible object of interest;
continuing to track the abandoned object;
tracking the person believed to be associated with the abandoned object to see if the person returns to the abandoned object; and
raising an alert when the person believed to be associated with the abandoned object does not return to the abandoned object within a threshold period of time.

13. The method of claim 12, wherein the alert identifies:
the abandoned object; and
the person believed to be associated with the abandoned object.

14. The method of claim 13, further comprising:
archiving an image of the abandoned object, an image of the person believed to be associated with the abandoned object and archiving an image of the object when the object was initially associated with the person who was associated with the object.

15. The method of claim 12 wherein when the person believed to be associated with the abandoned object does not return to the abandoned object within a threshold period of time, continuing to track the person believed to be associated with the abandoned object and provide a current location of the person believed to be associated with the abandoned object.

16. The method of claim 12, further comprising:
detecting that the abandon object has been moved by a new person other than the person believed to be associated with the abandoned object;
associating the new person with the abandoned object;
archiving an image of the new person;
tracking the abandoned object;
tracking the new person; and
raising an alert that the abandoned object has been moved by the new person.

17. A security system comprising:
a video camera for producing a video stream;
a controller operatively coupled to the video camera, the controller configured to:
receive a plurality of video frames of the video stream;
perform video analytics on one or more of the plurality of video frames to detect one or more objects in the video stream;
perform video analytics on one or more of the plurality of video frames to detect one or more persons in the video stream;
identify an object-person association between one of the objects detected in the video stream and one of the persons detected in the video stream, resulting in an object/person pair;
track the object of the object/person pair and the person of the object/person pair through subsequent video frames;
based on the track of the object of the object/person pair and the track of the person of the object/person pair, determine when the object of the object/person pair becomes abandoned by the person of the object/person pair; and
issue an alert when the object of the object/person pair becomes abandoned by the person of the object/person pair.

18. The security system of claim 17, wherein the alert identifies:
the abandoned object of the object/person pair; and
the person that abandoned the object of the object/person pair.

19. The security system of claim 17, wherein the controller is further configured to:
archive an image of the abandoned object of the object/person pair and an image of the person that abandoned the object of the object/person pair when the object of the object/person pair becomes abandoned by the person of the object/person pair.

20. The security system of claim 17, wherein after the object of the object/person pair becomes abandoned by the person of the object/person pair, the controller is configured to:
continue to track the abandoned object of the object/person pair;
continue to track the person that abandoned the object of the object/person pair; and
based on the continued tracking of the abandoned object of the object/person pair and the person that abandoned the object of the object/person pair, determine whether the person that abandoned the object of the object/person pair returns to the abandoned object of the object/person pair, and if so, determining that the abandoned object of the object/person pair is no longer abandoned by the person of the object/person pair.
